(19) United States
(12) Patent Application Publication
(10) Pub. No.: US 2008/0090941 A1
(43) Pub. Date: Apr. 17, 2008

(54) Process For Preparing Semi-Metallic Friction Material

(75) Inventors: Jiin-Huey Chern Lin, Winnetka, IL (US); Chien-Ping Ju, Kansas City, MO (US); Shu-Ching Ho, Tainan City (TW)

Correspondence Address: BACON & THOMAS, PLLC, 625 SLATERS LANE, FOURTH FLOOR, ALEXANDRIA, VA, 22314, US

(73) Assignee: Chien-Ping JU, Kansas City, MO (US)

(21) Appl. No.: 11/794,101

(22) PCT Filed: Dec. 27, 2005
(86) PCT No.: PCT/US05/47014

§ 371 Date: Jun. 25, 2007

(30) Foreign Application Priority Data
Dec. 27, 2004 (CN) 200410102494.0

(51) Int. Cl. F16D 69/02

(52) U.S. Cl. 523/149

(57) ABSTRACT

A process for preparing a semi-metallic friction material having improved thermal resistance includes preparing a semi-metallic composition containing (i) at least one carbonizable thermosetting resin as a binder; and (ii) at least one transition metal powder having a melting point higher than 1000° C. and density less than 10 g/ml; thermoforming said semi-metallic composition by curing said thermosetting resin; and heat-treating the resulting thermoformed product at a temperature of about 100 to 1000° C., preferably 200-600° C., to semi-carbonize said cured thermosetting resin.

### FIELD OF THE INVENTION

The present invention is related to a technique for preparing a semi-metallic friction material useful at least in the fabrication of a clutch or brake pad of cars and motorcycles.

### BACKGROUND OF THE INVENTION

Semi-metallic friction material was introduced in the late 1960s and has gained widespread usage in the mid-1970s. It has been exploited for parts such as clutch and brake pad used in automotive transmission in both dry and wet circumstances. The formulation of semi-metallic friction material takes advantage of using binder resins reinforced with metal, fillers, lubricants and abrasive particles. Generally speaking, when designing friction material to obtain desirable friction/wear properties, a binder resin should enclose great usefulness such as durability, stability, easiness of processing, and good heat-resistance.

To improve the mechanical and tribological performance of polymer-based friction material, one of the most efficient methods is to add various kinds of fibers into the matrix as reinforcement. Different kinds of fibers, e.g., metallic, glass, ceramic and carbon fibers, have been used.

In order to improve the high temperature performance of semi-metallic friction material, carbonization or semi-carbonization treatment of the material has been practiced. For example, Kamioka [Kamioka N., Japanese Laid-Open Patent Publication 63-219924, 1988] showed that hot-pressing a mesophase carbon-based friction material to a temperature of 400-650° C. with a pressure of 100-700 kg/cm² caused the friction coefficient of the material to remain stable at high temperatures. Ohya and Sayama [Ohya K, Sayama N., U.S. Pat. No. 5,344,854, 1994] reported improved anti-fade properties by semi-carbonizing a polycyclic aromatic pitch/cyanate ester resin-based friction material to a temperature of 270-800° C. By heat-treating a steel fiber-reinforced mesophase pitch/sulfur/aromatic nitro compound-matrix friction material to a temperature of 400-650° C., Kojima et al. [Kojima T, Sakamoto H, Kamioka N, Tokumura H., U.S. Pat. No. 5,279,777, 1994.] also observed an improved high temperature friction behavior.

The studies mentioned above have used pitch/mesophase pitch as a primary binder. Despite all the positive results due to carbonization/semi-carbonization treatment, it is known that, as a binder material, pitch has some inherent disadvantages, compared to a thermosetting resin such as phenolic resin. Typical examples for such disadvantages of pitch at least include heating-induced bloating [Savage G., Carbon yield from polymers. In Chapman, Hall, editors. Carbon-carbon composites, Chap. 4, London, 1993:120-121.] and low carbon yield [Thomas C R., What are Carbon-Carbon composites. In Thomas C R, editor. Essentials of Carbon-Carbon Composites, Chap. 1, The Royal Soc Chem, 1993:20].

Despite the facts that phenolic resin-based semi-metallic friction material possesses advantages such as excellent wear resistance, little environment pollution and little damage to counter face [Jia X, Zhou B, Chen Y, Jiang M, ling X. Study on worn surface layers of the friction materials and grey cast iron. Tribology 1995; 15(2):71-176], there are other problems. For example, frictional heating-induced thermal decomposition or liquescence of phenolic resin can cause friction of this type of material to fade away [Jacho M G. Physical and chemical changes of organic disk pads in service. Wear 1978; 46:163-175.; Anderson A E. Friction and wear of Automotive Brakes. In Henry S D, editor. ASM Handbook, Vol. 18, Metals Park, Ohio 44073: ASM International, 1992:569-577].

### SUMMARY OF THE INVENTION

The present invention discloses a method for semi-metallic friction material using a semi-carbonization process (higher than conventional post-cure temperature and lower than conventional carbonization treatment by a few hundreds of degrees). One example shows that, semi-carbonized at 600° C. can improve not only the wear behaviour but also the thermal resistance. Since fade (caused by high temperature) is one of the most important disadvantages for resin-based friction material, the large increase in thermal resistance would be highly beneficial to the application of semi-metallic friction material.

Preferred embodiments of the present invention include (but not limited to) the following items:
1. A process for preparing a semi-metallic friction material having improved thermal resistance comprising the following steps:
(a) preparing a semi-metallic composition comprising (i) at least one carbonizable thermosetting resin as a binder; and (ii) at least one transition metal powder having a melting point higher than 1000° C. and density less than 10 g/ml;
(b) thermoforming said semi-metallic composition by curing said thermosetting resin; and
(c) heat-treating the resulting thermoformed product at a temperature of about 100 to 1000° C., preferably 200-600° C., to semi-carbonize said cured thermosetting resin.
2. The process of Item 1, wherein said thermosetting resin in step (a) has a weight fraction from about 5 wt % to about 25 wt %, preferably 8-18 wt % and more preferably 9-15 wt %, in said semi-metallic composition.
3. The process of Item 1, wherein said thermosetting resin in step (a) is selected from the group consisting of phenolic resin, furfuryl alcohol, polyimide, polyester, polyphenylene oxide, epoxy resin and phenolic novolac epoxy resin.
4. The process of Item 1, wherein said transition metal in step (a) is selected from the group consisting of Cu, Fe, Ni, Co, Mn, Cr, Ti and Zr.
5. The process of Item 2, wherein said thermosetting resin in step (a) is phenolic resin and said transition metal in step (a) is copper.
6. The process of Item 1, wherein said semi-metallic composition in step (a) further comprises at least one friction regulator selected from the group consisting of barium sulfate, calcium sulfate, calcium silicate, calcium carbonate, silica, vermiculite, graphite, carbon, rubber, mica, cashew nut, barite, clay, chromite, molybdenum disulfide, calcium fluoride and metal sulfide.
7. The process of Item 1, wherein said semi-metallic composition in step (a) further comprises at least one fiber selected from the group consisting of metallic fiber, carbon fiber, ceramic fiber and glass fiber.
8. The process of Item 6, wherein said metallic fiber is selected from the group consisting of Cu or Cu alloy-based fiber, Fe or Fe alloy-based fiber, Ni or Ni alloy-based fiber, and Ti or Ti alloy-based fiber.
9. The process of Item 1, wherein said semi-metallic composition in step (a) further comprises at least one thermoplastic resin which is not pitch.
10. The process of Item 1, wherein said thermoforming in step (b) comprises curing said semi-metallic composition by hot pressing at a temperature which is from about 50° C. to about 150° C. above a softening temperature of said thermosetting resin.
11. The process of Items 1, 2, 5 or 10, wherein said thermoforming in step (b) comprises post-curing the cured thermosetting resin by heating at a temperature which is from about 50° C. to about 200° C. above the softening temperature of said thermosetting resin.
12. The process of Item 11, wherein said post-curing is conducted at an average heating rate of less than 10° C./min, preferably less than 5° C./min, and most preferably at about 1° C./min.
13. The process of Item 1, wherein said heat-treating in step (c) is conducted in vacuum or in an inert atmosphere, and preferably in an inert atmosphere.
14. A semi-metallic friction material prepared in accordance with the process defined in any one of Items 1 to 13.

### DETAILED DESCRIPTION OF THE INVENTION

The present invention discloses a method for semi-metallic friction material using a semi-carbonization process (higher than conventional post-cure temperature and lower than conventional carbonization treatment by a few hundreds of degrees) in attempt to improve its high temperature friction characteristics and durability. For simplicity, the terminology “carbonization” was used hereinafter, although the heat treatment within the present experimental ranges should be more precisely categorized as “semi-carbonization” treatment.

The present invention will be better understood through the following examples which merely are for illustration and not for limiting the scope of the present invention.

### Example 1

### Comparison Between Phenolic and Pitch

Experimental Procedures

The copper/phenolic resin-based friction materials were prepared from dry-mixing appropriate amounts of 200 mesh-sized phenolic resin powder (Orchid Resources Co., Taiwan) or pitch powder (Ashland, U.S.A.) and pure copper powder (Yuanki, Taiwan), followed by hot pressing at 180° C. (pitch was 120° C.) for 10 min under a load of 1 MPa. Before carbonization, the green compacts were post-cured in an air-circulated oven at 180° C. for 1 hr. After post-curing, the samples were heat-treated/carbonized in a furnace in nitrogen atmosphere at various heating rates.

The compressive strength of each sample was determined using a desk-top mechanical tester (Shimadzu AGS-500D, Kyoto, Japan) at a crosshead speed of 1.0 mm/min in line with ASTM D695-96 standard. The tribological performance of the material was evaluated by constant speed (1000 rpm) slide testing under a load of 1 MPa according to CNS 2586 standard method. A CNS 2472 cast iron disk (GC25) was used as the counter-face material. All tests were performed at ambient temperature in the atmosphere. The friction force, from which the friction coefficient can be calculated, was determined from the output of a strain gauge mounted on the arm carrying the pin. The initial coefficient of friction (hereinafter abbreviated as COF) was measured at about the 100^{th} rev; the average COF was measured between the 2000^{th} and 4000^{th} rev; and the final COF was measured after the 5500^{th} rev. The temperature variations due to friction were measured using a thermocouple mounted close (3 mm) to the sliding counter face. The sliding-induced weight loss and reduction in thickness of each sample were measured using an electronic balance (GM-1502, Sartorius, Germany) and a digital micrometer (APB-1D, Mitutoyo, Japan), respectively.

To further evaluate heat/oxidation resistance of the material, samples from different carbonization treatments were put into an air furnace at different temperatures (300, 400, 500, 600 and 700° C.) for various times (1, 5 and 10 min). After the treatment the changes in weight/density, dimensional stability, along with the oxidation condition of sample surface were evaluated.

Summarized Materials and Methods

Resin: 200 mesh-sized novolac type phenolic resin powder (Orchid Resources Co., Taiwan)
Pitch: powder (Ashland, U.S.A.)
Addition: pure copper powder (99.95, Yuanki, Taiwan)
Hot press: phenolic resin was 180° C. (pitch was 120° C.) for 10 min
Specimen size: 25 mm×25 mm×10 mm
Post-curing: heating rate 1° C./min. till 160° C., then 0.5° C./min. to 180° C., hold for 1 hr.
Carbonization: heating rate: 1° C./min. till 230° C., held for 60 min, then 0.5° C./min. to 600° C., hold for 30 min.
   Measurements
   Mechanical Properties:
   ASTM D695-96 standard, compressive strength
   Crosshead speed: 1 mm/min Support span: 40 mm
   SHIMADZU AGS-500D universal tester (Shimadzu Corporation, Kyoto, Japan)
   Coefficient of Friction (COF) and Weight Loss:
   Methods as Described in Experimental Procedures
   Heat/Oxidation Resistance

Methods as Described in Experimental Procedures

TABLE 1-1
Tribological performance of phenolic-based and
pitch-based friction material

| | | Compressive | Weight | |
|---|---|---|---|---|
| | | strength | loss | Coefficient |
| code | Composites | (MPa) | (%) | of friction |
| P6SS | Pitch: 12 wt % | 27.2 | −5.193 | Initial: 0.214 |
| | (50 vol %) | | | Average: |
| | Cu powder: 88 wt % | | | 0.063˜0.35 |
| | (50 vol %) | | | Final: 0.063 |
| 6SS | Phenolic resin: 12 wt % | 107.1 | −4.049 | Initial: 0.45 |
| | (50 vol %) | | | Average: |
| | Cu powder: 88 wt % | | | 0.35˜0.48 |
| | (50 vol %) | | | Final: 0.35 |

TABLE 1-2
Heat resistance of phenolic-based and pitch-based friction material

| | Dimension | Density | | | |
|---|---|---|---|---|---|
| | change | change | Weight | Surface | |
| | (%) | (%) | loss (g) | morphologies | Delamination |
| 6SS | | | | | |
| 400° C. | 0.06 | 0.06 | 0.02 | No change | No change |
| 1 min | | | | | |
| 400° C. | 0.09 | −0.03 | 0.01 | No change | No change |
| 5 min | | | | | |
| 400° C. | 0.10 | −0.04 | 0.01 | No change | No change |
| 10 min | | | | | |
| 500° C. | 0.21 | −0.10 | 0.02 | No change | No change |
| 1 min | | | | | |
| 500° C. | 0.28 | −0.22 | 0.01 | No change | No change |
| 5 min | | | | | |
| 500° C. | 0.32 | −0.26 | 0.01 | No change | No change |
| 10 min | | | | | |
| 600° C. | −0.52 | 0.58 | 0.01 | No change | No change |
| 1 min | | | | | |
| 600° C. | 0.57 | −0.56 | 0 | No change | No change |
| 5 min | | | | | |
| 600° C. | −1.61 | 1.52 | −0.02 | No change | No change |
| 10 min | | | | | |
| P6SS | | | | | |
| 400° C. | 3.99 | −3.78 | 0.01 | No change | No change |
| 1 min | | | | | |
| 400° C. | 7.18 | −6.64 | −0.01 | No change | No change |
| 5 min | | | | | |
| 400° C. | 8.44 | −7.94 | −0.03 | Fractured | Delaminated |
| 10 min | | | | | |
| 500° C. | 6.81 | −6.43 | −0.01 | No change | No change |
| 1 min | | | | | |
| 500° C. | 10.41 | −9.53 | −0.02 | No change | Delaminated |
| 5 min | | | | | |
| 500° C. | 14.39 | −12.68 | −0.02 | Fractured | Delaminated |
| 10 min | | | | | |
| 600° C. | 15.29 | −13.31 | −0.01 | No change | No change |
| 1 min | | | | | |
| 600° C. | 18.02 | −15.22 | −0.01 | Fractured | Delaminated |
| 5 min | | | | | |
| 600° C. | 21.69 | −17.78 | −0.01 | Fractured | Delaminated |
| 10 min | | | | | |

Summary of Ex. 1:

From Table 1-1 we can find the compressive strength (hereinafter abbreviated as C.S.) value of the P6SS sample prepared with pitch is only one fourth of that of the 6SS sample prepared with phenolic resin. The COF value of the P6SS sample varies significantly and is only about one half of that of the 6SS sample at the initial stage. With time the COF of P6SS decays very severely. The final COF of P6SS becomes less than 0.1. According to CNS 2586 standard, the allowed COF is about 0.2-0.6 at 300° C. and 0.25-0.6 at 350° C. The COF of the 6SS sample prepared with phenolic resin meets this standard.

From Table 1-2 there were no significant changes on the weight of the samples P6SS and 6SS. The delamination of P6SS led to the change of the dimension and density. Such short time heat-resistant test can closely simulate the abrupt temperature ramp of the brake, so we can know that the heat/oxidation resistant behavior of the 6SS sample prepared with phenolic resin is far more suitable for the brake application in comparison with the P6SS sample prepared with pitch.

### Example 2

### Effect of Preparation Parameters on Delamination Phenomenon

Experimental Description

The friction materials were prepared as the method in Ex. 1. The codes and preparation conditions of the samples are shown in Table 2-1. The preparation conditions included press temperature, press pressure, post-cure rate and carbonization rate. The morphology on the cross section of the samples was observed to serve as a basis of the control of the preparation conditions.

Sample Preparation

Resin: 200 mesh-sized novolac type phenolic resin powder (Orchid Resources Co., Taiwan)
Addition: pure copper powder (99.95, Yuanki, Taiwan)
Hot press: 100, 120 kg/cm², 160, 180, 200° C. for 10 min
Specimen size: 25 mm×25 mm×10 mm
Post-curing heating rate:
One step: 5° C./min. till 180° C., hold for 1 hr.
Two-step (I): heating rate 2° C./min. till 160° C., then 1° C./min. to 180° C., hold for 1 hr.
Two-step (II): heating rate 1° C./min. till 160° C., then 0.5° C./min. to 180° C., hold for 1 hr.
Carbonization heating rate:
(1) 10° C./min. till 230° C., held for 60 min, then 5° C./min. to 600° C., hold for 30 min.
(2) 10° C./min. till 230° C., held for 60 min, then 0.5° C./min. to 600° C., hold for 30 min.

(3) 1° C./min. till 230° C., held for 60 min, then 5° C./min. to 600° C., hold for 30 min.

TABLE 2-1
Effect of preparation parameters on delamination phenomenon

| | Hot press | Hot press | | | Carbonization rate | | | |
|---|---|---|---|---|---|---|---|---|
| | temperature | pressure | | | Temp. < 230° C. | Temp. > | Carbonization | |
| Code | (° C.) | (kg/cm²) | Post-cure rate | | (pre-carbonization) | 230° C. | temperature | Delamination |
| F | 180 | 100 | One step: | Tr*→18° C.: 5° C./min | None | None | None | Cracks |
| M | 180 | 100 | Two step (I): | Tr→160° C.: 2° C./min | None | None | None | Veins |
| | | | | 160□→180° C.: 1° C./min | | | | |
| S | 180 | 100 | Two step (II): | Tr→160° C.: 1° C./min | None | None | None | W/o crack |
| | | | | 160° C.→180° C.: | | | | |
| | | | | 0.5° C./min | | | | |
| FFF | 180 | 100 | One step: | Tr→180° C.: 5° C./min | 10° C./min | 5° C./min | 600° C. | Big cracks |
| MFF | 180 | 100 | Two step (I): | Tr→160° C.: 2° C./min | 10° C./min | 5° C./min | 600° C. | Cracks |
| | | | | 160° C.→180° C.: 1° C./min | | | | |
| FF | 180 | 100 | Two step (II): | Tr→160° C.: 1° C./min | 10° C./min | 5° C./min | 600° C. | Cracks |
| | | | | 160° C.→180° C.: | | | | |
| | | | | 0.5° C./min | | | | |
| 6FS | 180 | 100 | Same | | 10° C./min | 0.5° C./min | 600° C. | Holds |
| 6SF | 180 | 100 | Same | | 1° C./min | 5° C./min | 600° C. | Cracks |
| LSS | 160 | 100 | Same | | 1° C./min | 0.5° C./min | 600° C. | Cracks |
| HSS | 200 | 100 | Same | | 1° C./min | 0.5° C./min | 600° C. | Cracks |
| PSS | 180 | 120 | Same | | 1° C./min | 0.5° C./min | 600° C. | Veins |
| 6SS | 180 | 100 | Same | | 1° C./min | 0.5° C./min | 600° C. | W/o crack |

*Tr: room temperature

Summary of Ex. 2:

There were cracks observed on the cross section of the samples F and M, and the size of the cracks reduced when the post-cure rate became slow. When the cracks occurred on the cross section of the sample before carbonization, they were unlikely to disappear after carbonization (from FFF, MFF and FF). To reduce the size of the cracks and control the dimensional stability, the lower post-cure rate (S) was necessary. After evaluation of the result, the hot press conditions of 100 kg/cm² and 180° C. were chosen and the carbonization conditions of 1□/min at T<230□ and 0.5□/min at T>230□ were selected for the subsequent experiments.

### Example 3

### Effect of Carbonization on Heat/Oxidation Resistance

Experimental Description

The friction materials were prepared as the method in Example 1 and the heat/oxidation resistance was determined by using the same method as in Example 1. The codes and preparation conditions of the samples are shown in Table 2-1. The change of weight of 5 and 6SS samples after heat-resistant test was shown in Table 3-1.

Sample Preparation

Resin: 200 mesh-sized novolac type phenolic resin powder (Orchid Resources Co., Taiwan)
Addition: pure copper powder (99.95, Yuanki, Taiwan)
Hot press: 100 kg/cm², 180□ for 10 min
Specimen size: 25 mm×25 mm×10 mm
Post-curing: heating rate 1□/min. till 160□, then 0.5□/min. to 180□, hold for 1 hr.
Carbonization: heating rate: 1□/min. till 230□, held for 60 min, then 0.5□/min. to 600□, hold for 30 min.
   Measurements
   Heat/Oxidation Resistance

Methods as Described in Experimental Description

TABLE 3-1
Heat resistance of non-carbonized and carbonized friction material

| | | Weight | | | |
|---|---|---|---|---|---|
| Temp. | Time | change (g) | | Surface morphologies and oxidation | |
| (□) | (min.) | S | 6SS | S | 6SS |
| 300 | 1 | 0.01 | 0.01 | No change | No change |
| | 5 | −0.06 | 0 | No change | No change |
| | 10 | −0.10 | 0.01 | Partial puff up | No change |
| 400 | 1 | 0.01 | 0.02 | No change | No change |
| | 5 | −0.14 | 0.01 | Puff up | No change |
| | 10 | −0.28 | 0.01 | Oxidization (CuO) | Thin Cu₂O film |
| 500 | 1 | −0.12 | 0.02 | Puff up | No change |
| | 5 | −0.59 | 0.01 | Oxidization (CuO) | Thin Cu₂O film |
| | 10 | −0.75 | 0.01 | Oxidization (CuO) | Thin Cu₂O film |
| 600 | 1 | −0.59 | 0.01 | Oxidization (CuO) | Thin Cu₂O film |
| | 5 | −0.91 | 0 | Serious oxidization | Thin Cu₂O film |
| | 10 | −0.93 | −0.02 | Serious oxidization | Thin Cu₂O film |
| 700 | 1 | −1.88 | −0.05 | Serious damage | Serious damage |
| | 5 | −1.93 | −0.06 | Serious damage | Serious damage |
| | 10 | −2.10 | −0.09 | Serious damage | Serious damage |

Summary of Ex. 3:

As indicated in Table 3-1, under all conditions the material after carbonization treatment (6SS) is much more resistant to heat/oxidation than that without carbonization (S). To be specific, the sample S starts to show weight loss at 300□ for 5 min, while the sample 6SS starts to lose weight at 600□ for 10 min. The weight loss of the sample S is always 20-40 times larger than the sample 6SS under the same condition.

Examination of the heated/oxidized surfaces of the samples S and 6SS again confirms the superiority of the sample 6SS over the sample S in terms of heat/oxidation resistance. The surface of the sample 6SS remains almost intact up to 600□, while the surface of the sample S starts to show damage at much lower temperatures. Such short time heat-resistant test can closely simulate the abrupt temperature rump of the brake, so we know that the heat/oxidation resistant behavior of the sample carbonized is far more suitable for the brake application in comparison with that without carbonization.

### Example 4

### Effect of Carbonization on Compressive Strength and Hardness

Experimental Description

The friction materials were prepared as the method in Example 1. The codes and preparation conditions of the samples are shown in Table 4-1. The Rockwell hardness of each sample was measured according to the methods in CNS-2114 and 7473 standards, using Rockwell hardness machine under a load of 60 kg (HRR). The compressive strength of each sample was determined by using the same method as in Example 1.

Sample Preparation

Resin: 200 mesh-sized novolac type phenolic resin powder (Orchid Resources Co., Taiwan)
Addition: pure copper powder (99.95, Yuanki, Taiwan)
Hot press: 100 kg/cm², 180□ for 10 min
Specimen size: 25 mm×25 mm×10 mm
Post-curing: heating rate 1□/min. till 160□, then 0.5□/min. to 180□, hold for 1 hr.
Carbonization: heating rate: 1□/min. till 230□, held for 60 min, then 0.5□/min. to Tmax, hold for 30 min.
Carbonization temperature (Tmax): 400, 600, 800□
   Measurements
   Mechanical Properties:
   ASTM D695-96 standard, compressive strength
   Crosshead speed: 1 mm/min Support span: 40 mm
   SHIMADZU AGS-500D universal tester (Shimadzu Corporation, Japan)
   CNS-2114 and 7473 standards, Rockwell hardness (HRR)
   Based load: 10 kg Apply load: 60 kg

Rockwell hardness machine ATK-600 (Akashi, Japan)

TABLE 4-1
Mechanical properties

| | | | Carbonization | Compressive | |
|---|---|---|---|---|---|
| | | | temperature | strength | Hardness |
| Code | Post-cure rate | | (□) | (MPa) | (HRR) |
| C0 | Two step: | Tr→160□: 1□/min | None | 139.7 ± 10.5 | 14.7 ± 0.7 |
| | | 160□→180□: 0.5□/min | | | |
| C4 | Same | | 400 | 159.3 ± 6.3 | 18.0 ± 0.9 |
| C6 | Same | | 600 | 118.7 ± 7.3 | 14.7 ± 0.8 |
| C8 | Same | | 800 | 101.8 ± 9.9 | 7.0 ± 0.7 |

Summary of Ex. 4:

Table 4-1 compares the compressive strength (CS) and hardness values among C0, C4, C6 and C8. The CS and hardness values of sample C4 are both highest among all samples. However, a friction material having too high hardness may damage the counter face material. Combining the heat resistance performance and mechanical properties, C6 seems to be the best candidate for brake application.

### Example 5

### Effect of Carbonization on COF, Temperature and Wear

Experimental Description

The friction materials were prepared as the method in Example 1. The codes and preparation conditions of the samples are shown in Table 4-1. The sliding test of each sample was determined by using the same method as in Example 1.

Sample Preparation

Resin: 200 mesh-sized novolac type phenolic resin powder (Orchid Resources Co., Taiwan)
Addition: pure copper powder (99.95, Yuanki, Taiwan)
Hot press: 100 kg/cm², 180□ for 10 min
Specimen size: 25 mm×25 mm×10 mm
Post-curing: heating rate 1□/min. till 160□, then 0.5□/min. to 180□, hold for 1 hr.
Carbonization: heating rate: 1□/min. till 230□, held for 60 min, then 0.5□/min. to Tmax, hold for 30 min.
Carbonization temperature (Tmax): 400, 600, 800□
   Measurements
   COF and Weight Loss:

Methods as Described in Experimental Description

TABLE 5-1
Tribological performance of non-carbonized
and carbonized friction material

| | | | | Reduction in |
|---|---|---|---|---|
| | | | Weight loss | thickness |
| Code | COF | Temperature (□) | (g) | (mm) |
| C0 | Initial: 0.29 | Initial: 30 | 0.35 ± 0.02 | 0.14 ± 0.002 |
| | Average: | Average: 148˜188 | | |
| | 0.19˜0.22 | | | |
| | Final: 0.19 | Final: 243 | | |
| C4 | Initial: 0.18 | Initial: 30 | 0.50 ± 0.02 | 0.22 ± 0.002 |
| | Average: | Average: 130˜156 | | |
| | 0.09˜0.19 | | | |
| | Final: 0.17 | Final: 218 | | |
| C6 | Initial: 0.45 | Initial: 30 | 1.35 ± 0.04 | 0.43 ± 0.006 |
| | Average: | Average: 190˜230 | | |
| | 0.35˜0.48 | | | |
| | Final: 0.35 | Final: 305 | | |
| C8 | Initial: 0.17 | Initial: 30 | 2.19 ± 0.10 | 0.94 ± 0.009 |
| | Average: | Average: 238˜280 | | |
| | 0.37˜0.67 | | | |
| | Final: 0.4 | Final: 360 | | |

Summary of Ex. 5:

Each value was an average from ten samples. The sample without carbonization treatment (C0) exhibits a substantially stable, low COF value of about 0.2 throughout the test. The sample heat-treated to 400□ (C4) shows the lowest COF (0.1-0.15) at the early stage of sliding. After about 3000 rev, the COF value starts to increase and overlap that of C0. When the sample was heat-treated to 600□ (C6), the COF value largely increased to 0.3-0.4. The COF of the sample carbonized to 800□ (C8) further increased to 0.6-0.7 at the beginning, then rapidly declined to 0.35-0.45, which is still the highest among all four samples. The variations in sliding-induced temperature-rise show a similar trend to that in COF. In general, the higher the COF was observed, the higher the temperature was induced.

The COF of a phenolic resin matrix semi-metallic friction material (without carbonization) is usually about 0.2-0.4, before fade occurs at 300□ or higher. When fade occurs, the COF value largely drops. In the present study, sample C4 displays an unacceptably low COF value. However, when the heat treatment temperature was raised to 600□, the COF of the sample (C6) largely increased to an acceptable level according to CNS 2586 standard. In addition to the large increase in COF value, the COF of sample C6 did not show a sign of fade up to 300□ when the test was concluded.

As indicated in the Table 5-1, the average reduction in thickness as well as weight loss of the material after sliding for 6000 rev increase with increasing heat treatment/carbonization temperature. For example, the weight loss of sample C4 is larger than C0 by only 54%. Sample C6, however, has a weight loss larger than C0 by 280%. Sample C8 shows an even larger weight loss (larger than C0 by 520%).

Although C4 wears the least among three heat-treated samples, its exceptionally low COF makes the sample less practical for use as vehicle brakes or clutches. Sample C8 provides the highest COF value, however, its COF is unstable, especially during the early stage of sliding. Combined with its largest wear, it seems that the temperature of 800□ might be too high for carbonizing the present Cu/phenolic-based semi-metallic material. The observed much higher heat/oxidation resistance of sample C6 suggests that a simple carbonization treatment can largely improve the performance of the present semi-metallic friction material, especially for high energy/high temperature tribological applications.

### Example 6

### Effect of Carbonization Temperature on Worn Surface Morphology and Delamination Behavior

Experimental Description

The friction materials were prepared as the method in Example 1. The codes and preparation conditions of the samples are shown in Table 4-1. The surface morphology/chemistry of worn samples was characterized using a scanning electron microscope (SEM) (JXA-840, JEOL, Japan) equipped with an energy dispersive spectrometer (EDS) (AN10000/85S, Links, England).

Sample Preparation

Resin: 200 mesh-sized novolac type phenolic resin powder (Orchid Resources Co., Taiwan)
Addition: pure copper powder (99.95, Yuanki, Taiwan)
Hot press: 100 kg/cm², 180□ for 10 min
Specimen size: 25 mm×25 mm×10 mm
Post-curing: heating rate 1□/min. till 160□, then 0.5□/min. to 180□, hold for 1 hr.
Carbonization: heating rate 1□/min. till 230□, held for 60 min, then 0.5□/min. to Tmax, hold for 30 min.
Carbonization temperature (Tmax): 400, 600, 800□
   Measurements
   Surface Morphology/Chemistry

Scanning electron microscope (SEM) (JXA-840, JEOL, Japan) equipped with an energy dispersive spectrometer (EDS) (AN10000/85S, Links, England)

TABLE 6-1
Worn surface morphology and delamination behavior
of non-carbonized and carbonized friction material

| | | | Thickness of |
|---|---|---|---|
| Code | Surface morphology | Delamination behavior | debris (μm) |
| C0 | Covered with a layer | Delamination (easy to flake | 14.0˜25.0 |
| | of wear debris | off) | |
| C4 | Covered with a layer | Delamination (easy to flake | 7.5˜15.0 |
| | of wear debris | off) | |
| C6 | Deep, obvious traces | No delamination | None |
| C8 | Deep, obvious traces | No delamination | None |

Summary of Ex. 6:

The worn surfaces of samples C0 and C4 are covered with a layer of wear debris without obvious sliding tracks. Such kind of debris layer was also observed on the worn surface of other phenolic matrix semi-metallic friction material sliding against cast iron [Yuji H, Takahisa K. Effects of Cu powder, BaSO₄ and cashew dust on the wear and friction characteristics of automotive brake pads. Tribol Trans 1996; 39(2):346-353]. Adhesive wear appears to be the primary mechanism for C0 and C4. According to Yuji and Takahisa [Yuji H, Takahisa K. Effects of Cu powder, BaSO₄ and cashew dust on the wear and friction characteristics of automotive brake pads. Tribol Trans 1996; 39(2):346-353], the melted resin resulting from sliding-induced heating adheres to the worn surface and covers the sliding tracks. Adhesion properties of the resin are expected to influence friction and wear behavior of the semi-metallic material [Wright M A, Butson G. On-highway brake characterization and performance evaluation. Materially Speaking 1997; 11(1): 1-7.].

Cross-sectional SEM micrographs indicate that the debris layer on worn surfaces of samples C0 and C4 is loosely bonded to the substrate and can be as thick as 20 μm. Quite differently, the worn surfaces of samples C6 and C8 are covered with sharp sliding tracks and seen (with naked eye) with a dark blue color, which is an indication of oxidation. The rather smooth debris layer formed on C0 and C4 surfaces is considered to effectively protect the substrate material, leading to their relatively low friction and wear. On the other hand, samples C6 and C8 are free from such debris layer on their surfaces and thus exhibit relatively high friction and wear. For C6 and C8, the primary wear mechanism appears to be abrasive wear involving plowing and microcutting [Cenna A A, Doyle J, Page N W, Beehag A, Dastoor P. Wear mechanisms in polymer matrix composites abraded by bulk solids. Wear 2000; 240:207-214]. According to Kato [Kato K. Wear in relation to friction—a review. Wear 2000; 241:151-157.], when a friction material is made of a ductile material of moderate hardness, such as Al, Cu, Ni, Fe or their alloys, material in contact can plastically deform under the combined stresses of compression and shear. Severe plastic deformation leads to a large wear rate and rough surface. Under this condition protective surface layers can be easily destroyed. Compared to C8, the worn surface of C6 appears much smoother, that may explain its lower COF and wear.

### Example 7

### Effect of Carbonization Temperature on Wear-Induced Phase Transformation

Experimental Description

The friction materials were prepared as the method in Example 1. The codes and preparation conditions of the samples are shown in Table 4-1. X-ray diffraction (XRD) was performed on the samples both before and after wear, using an X-ray diffractometer (Rigaku D-max IIIV, Tokyo, Japan) with Ni-filtered CuKα radiation operated at 30 kV and 20 mA with a scanning speed of 4°/min. Matching each characteristic XRD peak with that compiled in JCPDS files identified the various phases of the samples.

Sample Preparation

Resin: 200 mesh-sized novolac type phenolic resin powder (Orchid Resources Co., Taiwan)
Addition: pure copper powder (99.95, Yuanki, Taiwan)
Hot press: 100 kg/cm², 180□ for 10 min
Specimen size: 25 mm×25 mm×10 mm
Post-curing: heating rate 1□/min. till 160□, then 0.5□/min. to 180□, hold for 1 hr.
Carbonization: heating rate: 1□/min. till 230□, held for 60 min, then 0.5□/min. to Tmax, hold for 30 min.
Carbonization temperature (Tmax): 400, 600, 800□
   Measurements
   Analysis
   X-ray diffractometer (Rigaku D-max 111V, Tokyo, Japan) operated at 30 kV and 20 mA.

Scanning speed 1°/min Radiation CuKα Ni-filtered

TABLE 7-1
Wear-induced phase transformation of non-carbonized and carbonized
friction material

| Code | Phase before sliding test | Phase after sliding test |
|---|---|---|
| C0 | Cu(200)Cu(111)CuO(111)CuO(002)C(002) | Same |
| C4 | Cu(200)Cu(111)CuO(111)CuO(002)C(002) | Same |
| C6 | Cu(200)Cu(111)CuO(111)CuO(002)C(002) | Cu(200)Cu(111)CuO(100)Cu₂O(110) |
| | | Cu₂O(111)Cu₂O(200)Fe₂O₃(110) |
| | | Fe₂O₃(104) CuO(111) |
| C8 | Cu(200)Cu(111)CuO(111)CuO(002)C(002) | Cu(200)Cu(111)Cu₂O(111)Cu₂O(200) |
| | | CuO(111) |

Summary of Ex. 7

The CuO existed in the surface of the copper-phenolic based semi-metallic friction material after hot-press (Table 7-1). During the sliding test the Cu₂O and Fe₂O₃ formed on the worm surface of C6 and C8. The oxidation of metal improved the tribological performance.

### Example 8

### Effect of Resin Contents on Compressive Strength and Hardness

Experimental Description

The friction materials were prepared as the method in Example 1. The codes and preparation conditions of the samples are shown in Table 8-1. The compressive strength of each sample was determined by using the same method as in Example 1. The Rockwell hardness of each sample was measured following the same method as in Example 4.

Sample Preparation

Resin: 200 mesh-sized novolac type phenolic resin powder (Orchid Resources Co., Taiwan)
Addition: pure copper powder (99.95, Yuanki, Taiwan)
Hot press: 100 kg/cm², 180□ for 10 min
Specimen size: 25 mm×25 mm×10 mm
Post-curing: heating rate 1□/min. till 160□, then 0.5□/min. to 180□, hold for 1 hr.
Carbonization: heating rate: 1□/min. till 230□, held for 60 min, then 0.5□/min. to 600□, hold for 30 min.
Resin contents: 30, 40, 50, 60, 70 vol %
   Measurements
   Mechanical Properties:
   ASTM D695-96 standard, compressive strength
   Crosshead speed: 1 mm/min Support span: 40 mm
   SHIMADZU AGS-500D universal tester (Shimadzu Corporation, Japan)
   CNS-2114 and 7473 standards, Rockwell hardness (HRR)
   Based load: 10 Kg Apply load: 60 kg

Rockwell hardness machine ATK-600 (Akashi, Japan)

TABLE 8-1
Mechanical properties of different resin contents

| | Compositions | | Compressive | |
|---|---|---|---|---|
| | (wt %/vol %) | | strength | Hardness |
| code | Phenolic resin | Cu powder | (MPa) | (HRR) |

| | | | | |
|---|---|---|---|---|
| R3 | 5.6/30.0 | 94.4/70.0 | 78.9 ± 3.2 | 8.0 ± 0.5 |
| R4 | 8.4/40.0 | 91.6/60.0 | 110.9 ± 6.7 | 13.7 ± 1.2 |
| R5 | 12.0/50.0 | 88.0/50.0 | 118.7 ± 7.3 | 14.68 ± 0.8 |
| R6 | 17.1/60.0 | 82.9/40.0 | 107.1 ± 3.6 | 10.5 ± 0.8 |
| R7 | 24.3/70.0 | 75.7/30.0 | 40.8 ± 3.9 | 5.5 ± 0.3 |

Summary of Ex. 8:

The maximum CS and hardness values were both observed from the sample R5, while the smallest CS and hardness values were from the samples R3 and R7. The compressive strengths of R4, R5 and R6 have all met the requirement for >100 MPa. The low CS and hardness values of the sample R3 may be explained by its low phenolic content which was insufficient in providing a reasonable bond between copper and semi-carbonized resin char. On the other hand, the low CS and hardness values of the sample R7 may be interpreted from its high resin content that caused excess porosity in the structure due to evolution of large amounts of gases.

### Example 9

### Effect of Resin Contents on COF, Temperature and Wear

Experimental Description

The friction materials were prepared as the method in Example 1. The codes and preparation conditions of the samples are shown in Table 8-1. The sliding test of each sample was determined by using the same method as in Example 1.

Sample Preparation

Resin: 200 mesh-sized novolac type phenolic resin powder (Orchid Resources Co., Taiwan)
Addition: pure copper powder (99.95, Yuanki, Taiwan)
Hot press: 100 kg/cm², 180□ for 10 min
Specimen size: 25 mm×25 mm×10 mm
Post-curing: heating rate 1□/min. till 160□, then 0.5□/min. to 180□, hold for 1 hr.
Carbonization: heating rate: 1□/min. till 230□, held for 60 min, then 0.5□/min. to 600□, hold for 30 min.
Resin contents: 30, 40, 50, 60, 70 vol %
   Measurements
   Coefficient of Friction (COF) and Weight Loss:

Methods as Described in Experimental Description

TABLE 9-1
Tribological performance of different resin contents

| | | | | Reduction in |
|---|---|---|---|---|
| | | | Weight | thickness |
| Code | COF | Temperature (□) | loss (g) | (mm) |
| R3 | Initial: 0.62 | Initial: 30 | 5.70 ± 0.07 | 1.03 ± 0.06 |
| (only 1100 | Average: | | | |
| rev) | 0.57˜0.62 | | | |
| | Final: 0.58 | Final: 216 | | |
| R4 | Initial: 0.45 | Initial: 30 | 3.51 ± 0.16 | 0.87 ± 0.04 |
| | Average: | Average: | | |
| | 0.2˜0.4 | 230˜280 | | |
| | Final: 0.23 | Final: 342 | | |
| R5 | Initial: 0.45 | Initial: 30 | 1.35 ± 0.04 | 0.43 ± 0.06 |
| | Average: | Average: | | |
| | 0.35˜0.48 | 190˜230 | | |
| | Final: 0.35 | Final: 305 | | |
| R6 | Initial: 0.31 | Initial: 30 | 1.09 ± 0.09 | 0.34 ± 0.01 |
| | Average: | Average: | | |
| | 0.13˜0.19 | 130˜180 | | |
| | Final: 0.10 | Final: 218 | | |
| R7 | Initial: 0.19 | Initial: 30 | 0.98 ± 0.06 | 0.24 ± 0.02 |
| | Average: | Average: | | |
| | 0.19˜0.20 | 150˜187 | | |
| | Final: 0.20 | Final: 252 | | |

Summary of Ex. 9

At the early stage R3 had a COF (around 0.6) higher than all other samples. This high COF, however, caused a faster increase in temperature and damage to the surface that was too severe to further any testing. On the other hand, R7 had the lowest COF value (about 0.15) among all materials tested. Apparently this unacceptably low COF value can hardly provide sufficient friction forces needed for brake or clutch application.

Besides the prematurely-failed R3, R5 exhibits the highest average COF value (0.35-0.48). Furthermore, this high COF did not show a significant fade throughout testing. On the other hand, although showing a high value (0.4-0.45) at the early stage, the COF of R4 faded quickly. At 2000 rev, its value declined to 0.25. The COF of R6 appears more stable than other materials. However, its COF value is still too low (about 0.2) in comparison with R5.

Average reductions in thickness and weight losses of the various materials at the conclusion of sliding (6000 rev) are also shown in Table 9.1. These wear data also indicate the great potential of R5. As can be seen from Table 9.1, both reduction in thickness and weight loss of the high-strength R5 are only slightly higher than R6 and R7, but far lower than R3 and R4. Despite their similar reduction-in-thickness and weight loss values, the COF values of both R6 and R7 are much lower than R5, as mentioned earlier. The low wear and low COF of R6 and R7 are probably due to the better coverage of a wear-induced lubricating debris film on surfaces due to their higher phenolic contents.

### Example 10

### Effect of Resin Contents on Worn Surface Morphology, Surface Roughness and Delamination Behavior

Experimental Description

The friction materials were prepared as the method in Example 1. The codes and preparation conditions of the samples are shown in Table 8-1. The mean surface roughness (Ra) values of the sliding surfaces before and after sliding test were determined using a profilometer (Surfcorder SE-40D, Kosaka Laboratory Ltd., Japan). The Ra value of the sample surface before the sliding test was controlled to about 4 μm. The surface morphology of worn samples was examined by using the same method as in example 6.

Sample Preparation

Resin: 200 mesh-sized novolac type phenolic resin powder (Orchid Resources Co., Taiwan)
Addition: pure copper powder (99.95, Yuanki, Taiwan)
Hot press: 100 kg/cm², 180□ for 10 min
Specimen size: 25 mm×25 mm×10 mm
Post-curing: heating rate 1□/min. till 160□, then 0.5□/min. to 180□, hold for 1 hr.
Carbonization: heating rate: 1□/min. till 230□, held for 60 min, then 0.5□/min. to 600□, hold for 30 min.
Resin contents: 30, 40, 50, 60, 70 vol %
   Measurements
   Surface Morphology/Chemistry
   Scanning electron microscope (SEM) (JXA-840, JEOL, Japan) equipped with a energy dispersive spectrometer (EDS) (AN10000/85S, Links, England)
   Surface Roughness (Ra)

Surface roughness profilometer SE-40D (Surfcorder, Kosaka Laboratory Ltd., Japan)

TABLE 10-1
Worn surface morphology, surface roughness and
delamination behavior of different resin contents

| | | | Delamination |
|---|---|---|---|
| Code | Surface morphology | surface roughness | behavior |
| R3 | Damaged seriously | 15.80 ± 0.31 | Edge chips seriously |
| R4 | Deep, obvious traces | 11.53 ± 0.18 | Edge chips seriously |
| R5 | Deep, obvious traces | 8.53 ± 0.15 | No change |
| R6 | Deep, obvious traces | 6.45 ± 0.12 | No change |
| R7 | Few deep, obvious traces | 4.61 ± 0.19 | No change |

Summary of Ex. 10

As indicated in Table 10-1, the surface roughness increased when the resin contents decreased.

### Example 11

### Effect of Resin Contents on Wear-Induced Phase Transformation

Experimental Description

The friction materials were prepared as the method in Example 1. The codes and preparation conditions of the samples are shown in Table 8-1. The XRD of each sample was determined by using the same method as in Example 7.

Sample Preparation

Resin: 200 mesh-sized novolac type phenolic resin powder (Orchid Resources Co., Taiwan)
Addition: pure copper powder (99.95, Yuanki, Taiwan)
Hot press: 100 kg/cm², 180□ for 10 min
Specimen size: 25 mm×25 mm×10 mm
Post-curing: heating rate 1□/min. till 160□, then 0.5□/min. to 180□, hold for 1 hr.
Carbonization: heating rate: 1□/min. till 230□, held for 60 min, then 0.5□/min. to 600□, hold for 30 min.
Resin contents: 30, 40, 50, 60, 70 vol %
   Measurements
   Analysis

X-ray diffractometer (Rigaku D-max IIIV, Tokyo, Japan) operated at 30 kV and 20 mA. Scanning speed 1°/min Radiation CuKα Ni-filtered

TABLE 11-1
Wear-induced phase transformation of different resin contents

| Code | Phase before sliding test | Phase after sliding test |
|---|---|---|
| R3 | Cu(200)Cu(111)CuO(111)CuO(002) | Cu(200)Cu(111)Cu₂O(111) |
| R4 | Cu(200)Cu(111)CuO(111)CuO(002) | Cu(200)Cu(111)CuO(100)Cu₂O(111) |
| | | Cu₂O(200)CuO(111) Fe₂O₃(110) |
| R5 | Cu(200)Cu(111)CuO(111)CuO(002) | Cu(200)Cu(111)CuO(111)Cu₂O(110) |
| | C(002) | CuO(100)Cu₂O(200)Cu₂O(111)Fe₂O₃(110) |
| | | Fe₂O₃(104) |
| R6 | Cu(200)Cu(111)CuO(111)CuO(002) | Cu(200)Cu(111)CuO(111)Cu₂O(110) |
| | C(002) | CuO(100)Cu₂O(200)Cu₂O(111)Fe₂O₃(110) |
| | | Fe₂O₃(104) |
| R7 | Cu(200)Cu(111)CuO(111)CuO(002) | Cu(200)Cu(111)CuO(100)Cu₂O(200) |
| | C(002) | Cu₂O(111) Fe₂O₃(110) Fe₂O₃(104) |

As can be seen from Table 11-1, the semi-carbonization treatment itself did not cause significant oxidation to the materials, although weak Cu₂O and CuO peaks were observed. The friction-induced heating, however, caused a major oxidation reaction to the surfaces of the materials, especially R4, R5 and R6. The lower oxide intensities observed in R3 and R7 are believed to be respectively associated with their earlier-mentioned short sliding time (due to pre-mature failure) and low COF value.

### Example 12

### Effect of Fiber Kind on Compressive Strength and Hardness (without Carbonization)

Experimental Description

The friction materials were prepared as the method in Example 1. The codes and preparation conditions of the samples are shown in Table 12-1. A fixed amount of fiber addition (10 wt %) was used to prepare each fiber-added material. The compressive strength of each sample was determined by using the same method as in Example 1. The Rockwell hardness of each sample was measured following the same method as in Example 4.

Sample Preparation

Resin: 200 mesh-sized novolac type phenolic resin powder (Orchid Resources Co., Taiwan)
Addition: pure copper powder (99.95, Yuanki, Taiwan)
Fiber: chopped steel fiber, copper fiber, brass fiber, SiO₂—Al₂O₃—K₂O based ceramic fiber, carbon fiber and cellulose polymeric fiber.
Hot press: 100 kg/cm², 180□ for 10 min
Specimen size: 25 mm×25 mm×10 mm
Post-curing: heating rate 1□/min. till 160□, then 0.5□/min. to 180□, hold for 1 hr.
   Measurements
   Mechanical Properties:
   ASTM D695-96 standard, compressive strength
   Crosshead speed: 1 mm/min Support span: 40 mm
   SHIMADZU AGS-500D universal tester (Shimadzu Corporation, Japan)
   CNS-2114 and 7473 standards, Rockwell hardness (HRR)
   Based load: 10 Kg Apply load: 60 kg

Rockwell hardness machine ATK-600 (Akashi, Japan)

TABLE 12-1
The codes and preparation conditions of the samples

| Sample | | |
|---|---|---|
| code | Fiber (diameter/length) | Fiber supplier |
| W/o fiber | | |
| Steel | Steel fiber (0.05 mm/1.5 mm) | Orchid Resources Co., |
| | | Taipei, Taiwan |
| Brass | Brass fiber (0.06 mm/5 mm) | Orchid Resources Co., |
| | | Taipei, Taiwan |
| Copper | Copper fiber (0.06 mm/5 mm) | Orchid Resources Co., |
| | | Taipei, Taiwan |
| Cellulose | Cellulose fiber (0.04 mm/1 mm) | Orchid Resources Co., |
| | | Taipei, Taiwan |
| Carbon | Carbon fiber (7 μm/4.5 mm) | Toray Co. Ltd., Taiwan |
| | | branch |
| Ceramic | Ceramic fiber (0.04 mm/1 mm) | Quancin Mat. Sci. & |
| | | Tech. Co. Ltd., Taiwan |

TABLE 12-2
Mechanical properties of samples reinforcement with different fiber
kind

| Code | Compressive strength (MPa) | Hardness (HRR) |
|---|---|---|
| W/o fiber | 139.7 ± 10.5 | 14.7 ± 0.7 |
| Steel | 132.0 ± 5.9 | 15.6 ± 0.9 |
| Brass | 144.1 ± 5.1 | 15.4 ± 0.7 |
| Copper | 145.6 ± 6.5 | 14.8 ± 0.8 |
| Cellulose | 86.0 ± 8.4 | 8.7 ± 0.5 |
| Carbon | 91.4 ± 10.8 | 9.3 ± 0.8 |
| Ceramic | 129.2 ± 12.2 | 13.1 ± 0.8 |

Summary of Ex. 12

Average values of Rockwell hardness and compressive strength of the series of friction materials are shown in Table 12-2. In terms of compressive strength, the fiber-added materials may be categorized into three groups. The first group, including copper and brass-added materials, displays compressive strengths higher than that of the fiber-free material. The second group, including steel and ceramic fiber-added materials, has a compressive strength level comparable to that without fiber. The third group, including cellulose and carbon fiber-added materials, shows compressive strengths lower than that without fiber. The hardness of the materials has a similar trend, except for copper and brass-added materials, which show similar hardness to that without fiber.

### Example 13

### Effect of Fiber Kind on COF, Temperature and Wear (without Carbonization)

Experimental Description

The friction materials were prepared as the method in Example 1. The codes and preparation conditions of the samples are shown in Table 12-1. The sliding test of each sample was determined by using the same method as in Example 1.

Variations in average COF and temperature (of 10 tests) with sliding distance of the series of materials are presented in Table 13-1.

Sample Preparation

Resin: 200 mesh-sized novolac type phenolic resin powder (Orchid Resources Co., Taiwan)
Addition: pure copper powder (99.95, Yuanki, Taiwan)
Fiber: chopped steel fiber, copper fiber, brass fiber, SiO₂—Al₂O₃—K₂O based ceramic fiber, carbon fiber and cellulose polymeric fiber.
Hot press: 100 kg/cm², 180□ for 10 min
Specimen size: 25 mm×25 mm×10 mm
Post-curing: heating rate 1□/min. till 160□, then 0.5□/min. to 180□, hold for 1 hr.
   Measurements
   Coefficient of Friction (COF) and Weight Loss:

Methods as Described in Experimental Description

TABLE 13-1
Tribological performance of samples reinforcement with different fiber
kind

| | | | | Reduction in |
|---|---|---|---|---|
| | | | | thickness |
| Code | COF | Temperature (□) | Weight loss (g) | (mm) |
| W/o fiber | Initial: 0.29 | Initial: 30 | 0.35 ± 0.02 | 0.14 ± 0.002 |
| | Average: 0.19˜0.22 | Average: 148˜188 | | |
| | Final: 0.19 | Final: 243 | | |
| Steel | Initial: 0.47 | Initial: 30 | 1.32 ± 0.04 | 0.53 ± 0.003 |
| | Average: 0.23˜0.57 | Average: 219˜235 | | |
| | Final: 0.25 | Final: 315 | | |
| Brass | Initial: 0.38 | Initial: 30 | 0.36 ± 0.01 | 0.15 ± 0.003 |
| | Average: 0.23˜0.35 | Average: 148˜174 | | |
| | Final: 0.23 | Final: 218 | | |
| Copper | Initial: 0.35 | Initial: 30 | 0.20 ± 0.01 | 0.08 ± 0.002 |
| | Average: 0.20˜0.37 | Average: 168˜194 | | |
| | Final: 0.28 | Final: 238 | | |
| Cellulose | Initial: 0.35 | Initial: 30 | 0.45 ± 0.03 | 0.14 ± 0.002 |
| | Average: 0.13˜0.19 | Average: 130˜176 | | |
| | Final: 0.13 | Final: 218 | | |
| Carbon | Initial: 0.24 | Initial: 30 | 0.87 ± 0.03 | 0.27 ± 0.003 |
| | Average: 0.16˜0.35 | Average: 200˜275 | | |
| | Final: 0.26 | Final: 346 | | |
| Ceramic | Initial: 0.29 | Initial: 30 | 0.27 ± 0.01 | 0.11 ± 0.003 |
| | Average: 0.16˜0.25 | Average: 143˜178 | | |
| | Final: 0.16 | Final: 259 | | |

Summary of Ex. 13

As indicated in Table 13-1, all fiber-added materials, except cellulose, exhibit higher average COF values than fiber-free material. Among all fibers, steel and carbon fibers have the strongest COF-enhancing effect (with average COF values higher than fiber-free material by 62 and 75%, respectively). The variation in temperature generally follows the same trend: Higher COF induces higher temperature. Steel fiber-added material shows the highest initial COF, however, its value largely decreases in the course of sliding. Other materials showing significant fade include brass, cellulose and ceramic fiber-added materials.

As shown in Table 13-1, steel fiber-added material has both largest reduction in thickness and largest weight loss (larger than fiber-free material by 267 and 277%, respectively). Carbon fiber-added material has the second largest reduction in thickness and largest weight loss (larger than fiber-free material by 87 and 140%, respectively). Brass fiber-added material has a similar wear to that without fiber. The material containing cellulose fiber shows a slightly higher wear, while the material containing ceramic fiber has a slightly lower wear than that without fiber. Among all fibers, copper fiber has the strongest effect on reducing wear.

As mentioned earlier, all fiber-added materials (except cellulose) exhibit higher COF values than the material without fiber. This phenomenon was also observed in other polymer-based friction materials. A combination of high friction and low wear is often pursued for many friction applications. To serve this purpose, copper fiber seems to be the best candidate among all fibers used in this study due to its relatively high and stable COF as well as low wear. According to the results of this work, an addition of 10 wt % copper fiber would increase the COF value (compared with the fiber-free material) by >45% and reduce the weight loss by >75%.

Despite the fact that steel fiber has the strongest COF-enhancing effect, it also results in the largest wear. Furthermore, quick fade occurs to the material containing steel fiber. For example, after 6000 rev, the COF of steel fiber-added material readily decays to a level lower than copper and carbon-added materials. Carbon fiber-added material has the second largest wear (larger than copper-added material by >200%), despite its second largest final COF value. The materials containing brass, cellulose and ceramic fibers exhibit higher initial COF values than the material without fiber, however, significant fade also occurs to these materials.

### Example 14

### Effect of Fiber Kind on Wear-Induced Worn Surface Morphology, Roughness and Delamination Behavior (without Carbonization)

Experimental Description

The friction materials were prepared as the method in Example 1. The codes and preparation conditions of the samples are shown in Table 12-1. The mean surface roughness (Ra) of the sliding surfaces before and after the sliding test was examined by using the same method as in Example 10. The surface morphology of worn samples was examined by using the same method as in Example 6.

Sample Preparation

Resin: 200 mesh-sized novolac type phenolic resin powder (Orchid Resources Co., Taiwan)
Addition: pure copper powder (99.95, Yuanki, Taiwan)
Fiber: chopped steel fiber, copper fiber, brass fiber, SiO₂—Al₂O₃—K₂O based ceramic fiber, carbon fiber and cellulose polymeric fiber.
Hot press: 100 kg/cm², 180□ for 10 min
Specimen size: 25 mm×25 mm×10 mm
Post-curing: heating rate 1□/min. till 160□, then 0.5□/min. to 180□, hold for 1 hr.
   Measurements
   Surface Morphology/Chemistry
   Scanning electron microscope (SEM) (JXA-840, JEOL, Japan) equipped with a energy dispersive spectrometer (EDS) (AN10000/85S, Links, England)
   Surface Roughness (Ra)

Surface roughness profilometer SE-40D (Surfcorder, Kosaka Laboratory Ltd., Japan)

TABLE 14-1
Worn surface morphology, Surface roughness and delamination
behavior

| | | | Surface |
|---|---|---|---|
| Code | Surface morphology | Delamination behavior | roughness (Ra) |
| W/o fiber | Covered with a layer of | Delaminated (easy to flake off) | 0.95 ± 0.12 |
| | softening resin | | |
| Steel | Obvious traces | A little delamination | 8.33 ± 0.42 |
| Brass | Covered with a layer of | Delaminated (easy to flake off) | 1.20 ± 0.18 |
| | softening resin | | |
| Copper | Obvious traces | A little delamination | 4.96 ± 0.24 |
| Cellulose | Covered with a layer of | Delaminated (easy to flake off) | 2.04 ± 0.16 |
| | softening resin | | |
| Carbon | The carbon fiber became | A little delamination | 7.70 ± 0.27 |
| | loose and broken in the | | |
| | matrix | | |
| Ceramic | Hot spots | Delaminated (easy to flake off) | 2.96 ± 0.21 |

Summary of Ex. 14

Except carbon fiber-added material which has a higher surface roughness (5.3 μm), all materials show a similar surface roughness level prior to sliding (about 4.0 μm). As shown in Table 14-1, the surface roughness of some materials (steel, copper, and carbon fiber-added materials) increases after sliding, while others (brass, cellulose and ceramic fiber-added as well as fiber-free materials) decrease in surface roughness. All fiber-added materials have a higher roughness level than fiber-free material (0.9 μm). Among all fiber-added materials, steel and carbon fiber-added materials have the largest roughness (8.3 and 7.7 μm, respectively), while brass fiber-added material has the smallest roughness (1.2 μm). The effect of fiber addition on surface roughness has a similar trend to that on wear, except for copper fiber-added material that has the smallest wear yet with third largest surface roughness.

As shown in Table 14-1, a layer of wear debris is observed to at least partially cover the worn surfaces of all materials after sliding. The degree of covering depends on the kind of material. For fiber-free as well as brass, cellulose and ceramic fiber-added materials, the debris layer almost fully covers their worn surfaces. In general, the debris layer is rather loosely bonded to the substrate material, as can be seen from the presence of numerous voids/cracks in it. For copper and carbon fiber-added materials, a partially-covered debris layer is typically observed. For steel fiber-added material, the debris layer is substantially absent. Furthermore, sliding tracks (indication of abrasive wear) on the worn surfaces of steel and copper fiber-added materials can be easily recognized with naked eye.

The mechanism of fade to the present fiber-free material and the materials containing brass, cellulose, carbon and ceramic fibers involves the formation of a lubricating, softened/melted phenolic resin-dominated debris layer on worn surface during sliding. This kind of debris layer was also observed in other phenolic-based friction materials at high temperatures [Yuji H, Takahisa K. Effects of Cu powder, BaSO₄ and cashew dust on the wear and friction characteristics of automotive brake pads. Tribol Trans 1996; 39(2):346-353]. As can be seen from Table 14-1, the worn surfaces of these materials are largely covered with a layer of debris after sliding. Concurrently the COF values of these materials markedly decline. In general, when a debris layer forms on the worn surface of a material, the surface roughness of the material decreases due to a “valley-filling” effect. This phenomenon can be seen in Table 14-1, with the exception of carbon fiber-added material, which has a larger initial surface roughness than all other materials due to the often-observed extrusion of fiber yarns. This poor bonding-induced extrusion, combined with fractured debris layer, causes the surface roughness of carbon fiber-added material to further increase after sliding.

Fade to steel fiber-added material apparently suggests a different mechanism, since the debris layer observed in other materials is substantially absent on the worn surface of steel fiber-added material. Instead, an abraded rough surface appears after sliding. The abrasive type wear is attributed to the large wear, large surface roughness as well as high initial COF. A possible interpretation for the fast decay in COF of steel fiber-added material might be the large abrasion-induced increase in surface roughness causing the contact area to reduce, that, in turn, results in a decreased COF. In an earlier study Gopal et al. also observed that fade occurs to steel fiber-reinforced phenolic matrix friction material at about 300□ [Gopal P, Dharani L R, Blum F D. Fade and wear characteristics of a glass-fiber-reinforced phenolic friction material. Wear 1994; 174: 119-127.]. As mentioned earlier, the typical worn surface of copper fiber-added material is partially covered with a debris layer. Abrasive type wear (with obvious sliding tracks) is observed in the uncovered area. The combination of the formation of a lubricating debris layer and abrasion (scraping debris off sliding surface) makes the copper fiber-added material stand out with a relatively high and more stable COF, yet with less wear, than other materials.

### Example 15

### Effect of Post-Curing Heating Rate on Compressive Strength and Hardness (without carbonization)

Experimental Description

The friction materials were prepared as the method in Example 1. The codes and preparation conditions of the samples are shown in Table 15-1. The compressive strength of each sample was determined by using the same method as in Example 1. The Rockwell hardness of each sample was measured following the same method as in Example 4.

Sample Preparation

Resin: 200 mesh-sized novolac type phenolic resin powder (Orchid Resources Co., Taiwan)
Addition: pure copper powder (99.95, Yuanki, Taiwan)
Hot press: 100 kg/cm², 180□ for 10 min
Specimen size: 25 mm×25 mm×10 mm
Post-curing heating rate:
(1) 10□/min. to 180□, hold for 1 hr.
(2) 5□/min. to 180□, hold for 1 hr.
(3) 1□/min. to 180□, hold for 1 hr.
(4) 0.5□/min. to 180□, hold for 1 hr.
(5) 1□/min. till 160□, then 0.5□/min. to 180□, hold for 1 hr.
   Measurements
   Mechanical Properties:
   ASTM D695-96 standard, compressive strength
   Crosshead speed: 1 mm/min Support span: 40 mm
   SHIMADZU AGS-500D universal tester (Shimadzu Corporation, Japan)
   CNS-2114 and 7473 standard, Rockwell hardness (HRR)
   Based load: 10 kg Apply load: 60 kg

Rockwell hardness machine ATK-600 (Akashi, Japan)

TABLE 15-1
The codes, preparation conditions and mechanical properties of
different post-curing heating rates

| | | | Compressive | |
|---|---|---|---|---|
| | | | strength | Hardness |
| Code | Post-cure rate | | (MPa) | (HRR) |
| W/o | None | | 40.5 ± 3.1 | None |
| 10 | One step: | Tr→180□:10□/min | 75.3 ± 4.5 | 10.8 ± 0.5 |
| 5 | One step: | Tr→180□:5□/min | 77.9 ± 8.1 | 11.9 ± 1.0 |
| 1 | One step: | Tr→180□:1□/min | 134.9 ± 5.9 | 13.7 ± 1.2 |
| 0.5 | One step: | Tr→180□:0.5□/min | 138.2 ± 6.8 | 14.0 ± 0.8 |
| 1/0.5 | Two step: | Tr→160□:1□/min | 139.7 ± 10.5 | 14.7 ± 0.7 |
| | | 160□→180□:0.5□/min | | |

Summary of Ex. 15

The results might be categorized into two groups in terms of compressive strength. The first group including the samples of w/o post-cured, 10□/min and 5□/min, showed C.S. lower than the second group including 1□/min, 0.5□/min and 1/0.5□/min. Compared to the sample post-cured, the sample w/o post-curing had C.S. values almost a half of the sample 5□/min. The hardness of the samples w/o post-curing could not be measured because the sample broke seriously during hardness test. The post-curing can improve many properties; the hardness and C.S. values of a phenolic part will increase during the post-curing. The mechanical properties of the friction material will be improved with a reduced post-curing heating rate. Apparently the copper/phenolic-based semi-metal post-cured at lower rate can increase the hardness level of the material.

### Example 16

### Effect of Post-Curing Heating Rate on Wear-Induced Temperature, COF And Wear (without Carbonization)

Experimental Description

The friction materials were prepared as the method in Example 1. The sliding test of each sample was determined by using the same method as in Example 1.

Sample Preparation

Resin: 200 mesh-sized novolac type phenolic resin powder (Orchid Resources Co., Taiwan)
Addition: pure copper powder (99.95, Yuanki, Taiwan)
Hot press: 100 kg/cm², 180□ for 10 min
Specimen size: 25 mm×25 mm×10 mm
Post-curing heating rate:
(1) 10□/min. to 180□, hold for 1 hr.
(2) 5□/min. to 180□, hold for 1 hr.
(3) 1□/min. to 180□, hold for 1 hr.
(4) 0.5□/min. to 180□, hold for 1 hr.
(5) 1□/min. till 160□, then 0.5□/min. to 180□, hold for 1 hr.
   Measurements
   COF and Weight Loss:

Methods as Described in Experimental Description

TABLE 16-1
Tribological performance of different post-curing heating rates

| | | | | Reduction |
|---|---|---|---|---|
| Code | COF | Temperature (□) | Weight loss (g) | in thickness (mm) |
| 5 | Initial: 0.23 | Initial: 30 | 0.50 ± 0.05 | 0.23 ± 0.003 |
| | Average: 0.12˜0.19 | Average: 148˜188 | | |
| | Final: 0.16 | Final: 243 | | |
| 1 | Initial: 0.28 | Initial: 30 | 0.39 ± 0.02 | 0.16 ± 0.01 |
| | Average: 0.15˜0.21 | Average: 149˜179 | | |
| | Final: 0.19 | Final: 233 | | |
| 1/0.5 | Initial: 0.29 | Initial: 30 | 0.35 ± 0.02 | 0.14 ± 0.002 |
| | Average: 0.19˜0.22 | Average: 148˜188 | | |
| | Final: 0.19 | Final: 243 | | |

Summary of Ex. 16

At beginning of sliding test, the COF of the sample 1/0.5□/min was larger than that of the sample 5□/min. After 3000 rev it was still larger than that of the sample 5□/min. The friction-induced heat made the sample 5□/min damaged after 3000 rev, which results in the unstable COF and larger weight losses. The sample 1□/min had almost the same COF with the sample 1/0.5□/min. The sample 1/0.5□/min showed a relatively stable COF during the test. From the data the sample 1□/min and 1/0.5□/min could maintain COF about 0.2 at about 250□. The reductions in thickness/weight losses of the sample 1/0.5□/min, 1□/min and 5□/min after sliding for 6000 rpm are given in Table 16-1. The sample 5□/min had larger weight loss (larger than 1/0.5□/min by 42.9%) and larger reductions in thickness (larger than 1/0.5□/min by 64.3%) due to the surface damage. The reductions in thickness/weight loss of the sample 1□/min were almost the same as the sample 1/0.5□/min. In wear behavior the sample 1□/min acted almost the same as the sample 1/0.5□/min, but inferior to the sample 1/0.5□/min in mechanical properties and dimensional stability.

When the post-curing heating rate is too high, the cross-linking reaction may be not completed. A suitable post-curing heating rate will render the cross-linking reaction of the resin complete in the semi-metallic friction material, which results in better mechanical and tribological properties of the semi-metallic friction material. The curing condition (1/0.5□/min) is considered optimal for the mechanical and tribological properties of the semi-metallic friction material.

### Example 17

### Effect of Fiber Kind on Compressive Strength and Hardness (Carbonized)

Experimental Description

The friction materials were carbonized to 600□ and prepared as the method in Example 1. The series of fiber used are shown in Table 12-1. The compressive strength of each sample was determined by using the same method as in Example 1. The Rockwell hardness of each sample was measured following the same method as in Example 4.

Sample Preparation

Resin: 200 mesh-sized novolac type phenolic resin powder (Orchid Resources Co., Taiwan)
Addition: pure copper powder (99.95, Yuanki, Taiwan)
Fiber: chopped steel fiber, copper fiber, brass fiber, SiO₂—Al₂O₃—K₂O based ceramic fiber, carbon fiber and cellulose polymeric fiber.
Hot press: 100 kg/cm², 180□ for 10 min
Specimen size: 25 mm×25 mm×10 mm
Post-curing: heating rate 1□/min. till 160□, then 0.5□/min. to 180□, hold for 1 hr.
Carbonization: heating rate: 1□/min. till 230□, held for 60 min, then 0.5□/min. to 600□, hold for 30 min.
   Measurements
   Mechanical Properties:
   ASTM D695-96 standard, compressive strength
   Crosshead speed: 1 mm/min Support span: 40 mm
   SHIMADZU AGS-500D universal tester (Shimadzu Corporation, Japan)
   CNS-2114 and 7473 standard, Rockwell hardness (HRR)
   Based load: 10 kg Apply load: 60 kg

Rockwell hardness machine ATK-600 (Akashi, Japan)

TABLE 17-1
Mechanical properties of samples reinforced with
different fibers (carbonized)

| | Compressive strength | Hardness |
|---|---|---|
| Code | (MPa) | (HRR) |
| W/o fiber | 118.7 ± 7.3 | 14.68 ± 0.8 |
| Steel | 78.7± | 9.63 ± 0.8 |
| Brass | 91.54± | 10.44 ± 0.5 |
| Copper | 94.83± | 12.85 ± 0.6 |
| Cellulose | 42.85 ± 5.0 | 5.36 ± 0.3 |
| Carbon | 18.75 ± 2.3 | Broken |
| Ceramic | 52.1 ± 4.8 | 5.85 ± 0.5 |

Summary of Ex. 17

Compared to Ex. 12, the compressive strength and hardness of the friction materials after carbonization shown in Table 17-1 decreased. The fiber-reinforced material had lower C.S. value and hardness than the sample w/o fiber. Especially, non-metal fiber-reinforced material had C.S. value and hardness only about a half of the sample w/o fiber.

### Example 18

### Effect of Fiber Kind on COF, Temperature and Wear (Carbonized)

Experimental Description

The friction materials were carbonized to 600□ and prepared as the method in Example 1. The series of fiber used are shown in Table 12-1. The sliding test of each sample was determined by using the same method as in Example 1.

Sample Preparation

Resin: 200 mesh-sized novolac type phenolic resin powder (Orchid Resources Co., Taiwan)
Addition: pure copper powder (99.95, Yuanki, Taiwan)
Fiber: chopped steel fiber, copper fiber, brass fiber, SiO₂—Al₂O₃—K₂O based ceramic fiber, carbon fiber and cellulose polymeric fiber.
Hot press: 100 kg/cm², 180□ for 10 min
Specimen size: 25 mm×25 mm×10 mm
Post-curing: heating rate 1□/min. till 160□, then 0.50/min. to 180□, hold for 1 hr.
Carbonization: heating rate: 1□/min. till 230□, held for 60 min, then 0.5□/min. to 600□, hold for 30 min.
   Measurements
   Coefficient of Friction (COF) and Weight Loss:

Methods as Described in Experimental Description

TABLE 18-1
Tribological performance of samples reinforcement with different fiber
kind (carbonized)

| | | | | Reduction in |
|---|---|---|---|---|
| | | | Weight | thickness |
| Code | COF | Temperature (□) | loss (g) | (mm) |
| W/o fiber | Initial: 0.45 | Initial: 30 | 1.35 ± 0.04 | 0.43 ± 0.06 |
| | Average: 0.35˜0.48 | Average: 190˜230 | | |
| | Final: 0.35 | Final: 305 | | |
| Steel | Initial: 0.50 | Initial: 30 | 3.83 ± 0.23 | 0.95 ± 0.10 |
| | Average: 0.21˜0.44 | Average: 140˜250 | | |
| | Final: 0.28 | Final: 330 | | |
| Brass | Initial: 0.44 | Initial: 30 | 2.79 ± 0.14 | 0.81 ± 0.07 |
| | Average: 0.35˜0.47 | Average: 130˜250 | | |
| | Final: 0.45 | Final: 320 | | |
| Copper | Initial: 0.48 | Initial: 30 | 1.98 ± 0.16 | 0.74 ± 0.07 |
| | Average: 0.33˜0.53 | Average: 150˜250 | | |
| | Final: 0.34 | Final: 320 | | |
| Cellulose | Initial: 0.35 | Initial: 30 | 0.54 ± 0.02 | 0.16 ± 0.03 |
| | Average: 0.13˜0.19 | Average: 130˜230 | | |
| | Final: 0.19 | Final: 250 | | |
| Carbon | Initial: 0.38 | Initial: 30 | 1.26 ± 0.06 | 0.33 ± 0.05 |
| | Average: 0.29˜0.51 | Average: 200˜450 | | |
| | Final: 0.51 | Final: 480 | | |
| Ceramic | Initial: 0.21 | Initial: 30 | 11.38 ± 0.16 | 2.92 ± 0.15 |
| | Average: 0.21˜0.38 | Average: 120˜250 | | |
| | Final: 0.38 | Final: 330 | | |

Summary of Ex. 18

The COF, temperature, weight loss and reduction in thickness of the series of carbonized friction materials are shown in Table 18-1. Compared to Ex. 13, the COF and wear of the friction materials after carbonization increased. In Ex. 13, copper fiber-reinforced material had the best wear properties. According to Table 18-1, the sample w/o fiber had the best properties than the other samples. To improve the heat resistance of the semi-metal friction material fiber addition is not necessary when the semi-metal friction material is treated with carbonization.

From the data collected from Table 13-1 and 18-1 as shown in Table 19, we can find that heat treatment (carbonization) is more effective than fiber addition overall.

TABLE 19
Tribological performance of samples reinforcement with copper fiber or
carbonization

| | | | | Reduction in |
|---|---|---|---|---|
| | | | Weight | thickness |
| Code | COF | Temperature (□) | loss (g) | (mm) |
| W/o fiber | Initial: 0.29 | Initial: 30 | 0.35 ± 0.02 | 0.14 ± 0.002 |
| W/o | Average: 0.19˜0.22 | Average: 148˜188 | | |
| carbonization | Final: 0.19 | Final: 243 | | |
| Copper fiber | Initial: 0.35 | Initial: 30 | 0.20 ± 0.01 | 0.08 ± 0.002 |
| W/o | Average: 0.20˜0.37 | Average: 168˜194 | | |
| carbonization | Final: 0.28 | Final: 238 | | |
| W/o fiber | Initial: 0.45 | Initial: 30 | 1.35 ± 0.04 | 0.43 ± 0.06 |
| 600° C. | Average: 0.35˜0.48 | Average: 190˜230 | | |
| | Final: 0.35 | Final: 305 | | |

1. A process for preparing a semi-metallic friction material having improved thermal resistance comprising the following steps:
(a) preparing a semi-metallic composition containing no thermal plastic resin and comprising (i) at least one carbonizable thermosetting resin as a binder; and (ii) at least one transition metal powder having a melting point higher than 1000° C. and density less than 10 g/ml;
(b) thermoforming said semi-metallic composition by curing said thermosetting resin; and
(c) heat-treating the resulting thermoformed product at a temperature of about 100 to 1000° C., preferably 200-600° C., to semi-carbonize said cured thermosetting resin.

2. The process of claim 1, wherein said thermosetting resin in step (a) has a weight fraction from about 5 wt % to about 25 wt %, preferably 8-18 wt % and more preferably 9-15 wt %, in said semi-metallic composition.

3. The process of claim 1, wherein said thermosetting resin in step (a) is selected from the group consisting of phenolic resin, furfuryl alcohol, polyimide, polyester, polyphenylene oxide, epoxy resin and phenolic novolac epoxy resin.

4. The process of claim 1, wherein said transition metal in step (a) is selected from the group consisting of Cu, Fe, Ni, Co, Mn, Cr, Ti and Zr.

5. The process of claim 2, wherein said thermosetting resin in step (a) is phenolic resin and said transition metal in step (a) is copper.

6. The process of claim 1, wherein said semi-metallic composition in step (a) further comprises at least one friction regulator selected from the group consisting of barium sulfate, calcium sulfate, calcium silicate, calcium carbonate, silica, vermiculite, graphite, carbon, rubber, mica, cashew nut, barite, clay, chromite, molybdenum disulfide, calcium fluoride and metal sulfide.

7. The process of claim 1, wherein said semi-metallic composition in step (a) further comprises at least one fiber selected from the group consisting of metallic fiber, carbon fiber, ceramic fiber and glass fiber.

8. The process of claim 6, wherein said metallic fiber is selected from the group consisting of Cu or Cu alloy-based fiber, Fe or Fe alloy-based fiber, Ni or Ni alloy-based fiber, and Ti or Ti alloy-based fiber.

9. The process of claim 1, wherein said semi-metallic composition in step (a) further comprises at least one thermoplastic resin which is not pitch.

10. The process of claim 1, wherein said thermoforming in step (b) comprises curing said semi-metallic composition by hot pressing at a temperature which is from about 50° C. to about 150° C. above a softening temperature of said thermosetting resin.

11. The process of claim 1, wherein said thermoforming in step (b) comprises post-curing the cured thermosetting resin by heating at a temperature which is from about 50° C. to about 200° C. above the softening temperature of said thermosetting resin.

12. The process of claim 11, wherein said post-curing is conducted at an average heating rate of less than 10° C./min, preferably less than 5° C./min, and most preferably at about 1° C./min.

13. The process of claim 1, wherein said heat-treating in step (c) is conducted in vacuum or in an inert atmosphere, and preferably in an inert atmosphere.

14. A semi-metallic friction material prepared in accordance with the process defined in any one of claim 1.

15. The process of claim 1, wherein said semi-metallic composition used in step (a) contains no pitch.
